(19) United States
(12) Patent Application Publication
(10) Pub. No.: US 2020/0364809 A1
(43) Pub. Date: Nov. 19, 2020

(54) HYBRID PRICE PRESENTATION STRATEGY USING A PROBABILISTIC HOTEL DEMAND FORECAST MODEL

(71) Applicant: INTERNATIONAL BUSINESS MACHINES CORPORATION, Armonk, NY (US)

(72) Inventors: Sunhwan Lee, San Mateo, CA (US); Yue Guan, San Jose, CA (US); Pawan Chowdhary, San Jose, CA (US); Guangjie Ren, Belmont, CA (US)

(21) Appl. No.: 16/413,590

(22) Filed: May 15, 2019

(51) Int. Cl. G06Q 50/12; G06Q 10/02; G06N 7/00; G06Q 30/02

(52) U.S. Cl. CPC G06Q 50/12; G06Q 30/0283; G06N 7/005; G06Q 10/02

(57) ABSTRACT

A computer implemented method includes receiving a first set of data comprising financial data of a company and at least one of holiday data, industrial event data, or weather data. A probabilistic hotel demand forecast is computed for a hotel in a location based on a statistical analysis of prior hotel stays at the hotel in the location with an adjustment based on at least the financial data of the first set of data. The adjustment can be computed by the computer based on a prior effect of at least the financial data on a number of prior hotel stays. The resulting probabilistic hotel demand forecast can be displayed on a user terminal device. This forecast may be used to generate a future pricing strategy.

### BACKGROUND

### Technical Field

The present disclosure generally relates to computer implemented systems and methods for providing a user with an optimized approach for pricing of a commodity, and more particularly, to a computer implemented system and method for determining hotel demand based on real-time data for providing a user with an optimized approach for pricing a commodity, such as hotel room pricing.

### Description of the Related Art

The travel Industry is one of the most prolific in terms of service providers and service enablers. Enterprise travel is about a 1.3 trillion dollar industry and about 40% of which is on accommodations with most of that going to major hotel brands. Many corporations have dedicated hotel category leads that manage hotel programs that include rate negotiation and rate type, such as fixed price or discount off the dynamic price. The enterprise buyers are looking ways to reduce cost but at the same time provide the best travel experience.

Enterprise hotel buyers lack tools to help them develop a strategy to negotiate rate types and come out optimal solution. The existing pricing strategy for enterprise hotel programs is typically either fixed rate or of dynamic rate (e.g., at a fixed discount level) within a predetermined time.

### SUMMARY

According to various embodiments, a computing device, a non-transitory computer readable storage medium, and a method are provided for forecasting a demand for a hotel. A first set of data comprising financial data of a company and at least one of holiday data, industrial event data, or weather data is received. A probabilistic hotel demand forecast is computed for a hotel in a location based on a statistical analysis of prior hotel stays at the hotel in the location with an adjustment based on at least the financial data of the first set of data. The adjustment is computed by the computer based on a prior effect of at least the financial data on a number of prior hotel stays. The probabilistic hotel demand forecast for the hotel in the location is displayed on a user terminal device.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a schematic representation of a system that provides a hybrid price presentation strategy, according to an illustrative embodiment.

FIG. 2 is a conceptual block diagram of a hybrid price presentation strategy, according to an illustrative embodiment.

FIG. 3 is a flow chart describing how a particular pricing model may be modified if originally rejected by the hotel, according to an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. in other instances, well-known methods, procedures, components, and/or circuitry have been described at a relatively high-level, without detail, in order to avoid unnecessarily obscuring aspects of the present teachings.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM) a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present disclosure generally relates to computer implemented systems and methods that provide on a user interface a hybrid of both a fixed pricing strategy and a dynamic pricing strategy that uses a real-time probabilistic hotel demand forecast model that leverages historical volumes and external data sources to generate a probabilistic hotel demand forecast. The systems and methods can use this hotel demand forecast model to provide a hotel pricing strategy, which can provide the user with a tool, based on real data, to make the most of the negotiation process for better cost saving.

As used herein, a “fixed” pricing strategy may be a price strategy where an agreed upon price is used. In the context of hotel room booking, a fixed price may be one price that each person booking the room pays. A fixed pricing strategy may include a commitment, referring to a minimum number of rooms that must be booked over a predetermined period of time. A “dynamic” pricing strategy may refer to an amount provided off from the standard rate at the time of booking. The amount of discount may be a given dollar amount, a percentage or the like. A dynamic pricing strategy may include a commitment, similar to the fixed pricing strategy. A “hybrid” pricing strategy may use a combination of both the fixed and dynamic pricing strategies.

The probabilistic hotel demand forecast may be calculated for a particular “location”. As used herein, this “location” may refer to particular city, county, or any predefined region, such as within a 20 mile radius of hotel property X. As used herein, the term “hotel”, with respect to a probabilistic “hotel” demand forecast, may refer to a single hotel, a subset of a chain of hotels belonging to a particular brand, or an entirety of a chain of hotels belonging to a particular brand. For example, a particular hotel brand may include a one or more suite hotels and one or more room-based hotels, such that one subset of the chain may refer to the suite hotels in the location, and one subset of the chain may refer to the room-based hotels in the location.

Embodiments of the present disclosure propose a hybrid of both fixed and dynamic pricing strategies and provide more degrees of freedom, as compared to conventional pricing strategy systems. The system and methods according to the present disclosure can be used to provide data to make the most of the negotiation process for better cost saving, according to the probabilistic hotel demand forecast models. In some embodiments of the present disclosure, a two-phase pricing strategy may be provided to the user, including a long term (quarterly or yearly) strategic contract plus a short term (daily or weekly) real time update.

The probabilistic hotel demand forecast model leverages historical volumes from internal databases and external data sources. The historical hotel volume time series can be derived from expense, booking and card data of company employees' enterprise travel records, and company's internal master hotel matching database, for example.

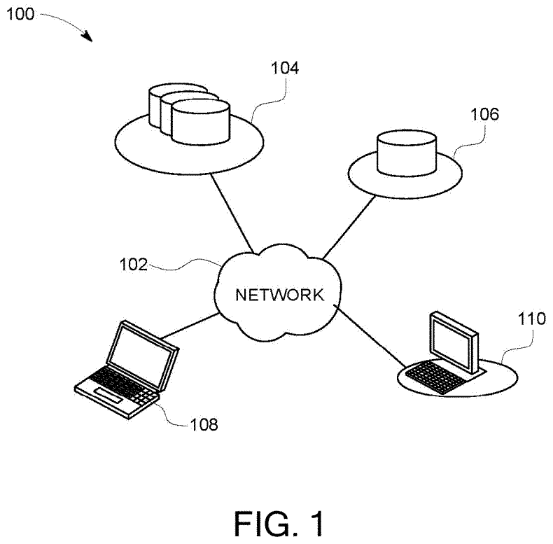

Referring to FIG. 1, a schematic representation of a system 100 for performing methods of according to embodiments of the present disclosure. The system 100 can include a network 102 for operably interconnecting external databases 104, internal databases 106, user terminal devices 108, and, optionally, hotel user terminal devices 110, as discussed in greater detail below. The external databases 104 may provide various types of data taken from various sources external to the company, such as weather data, holiday data, public financial data for a company performing the various methods described herein, industrial event data, such as conferences, meetings or the like that are related to the company's business, and the like. The internal databases 106 can provide actual travel data for the company of interest, internal travel policy data, and the similar data internal to the company. The user terminal devices 108 can include various types of computing devices, including desktop computers, laptop computers, tablet computer, mobile smart communication devices, and the like. The hotel user terminal devices 110 can include similar types of computing devices as the user terminal devices 108, however, as described below, the hotel user terminal devices 110 may be limited in what information is received or what access to the other databases 104, 106 is permitted. For example, the hotel user terminal devices 110 may not have access to the data or algorithms used to generate the probabilistic hotel demand forecast but may have access to the actual number of rooms that is forecasted to be used over an upcoming predetermined time period.

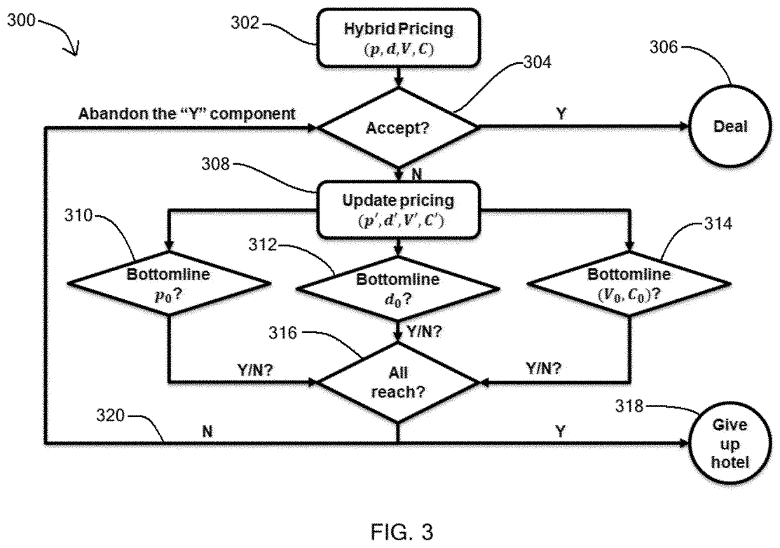

With the foregoing overview of an example system 100 and conceptual block diagram of a hybrid price presentation strategy 200, it may be helpful now to consider a high-level discussion of an example process. To that end, FIG. 3 presents an illustrative process of providing a hybrid price strategy 300. Process 300 is illustrated as a collection of blocks in a logical flowchart, which represent sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process. For discussion purposes, the process 300 is described with reference to the system 100 of FIG. 1.

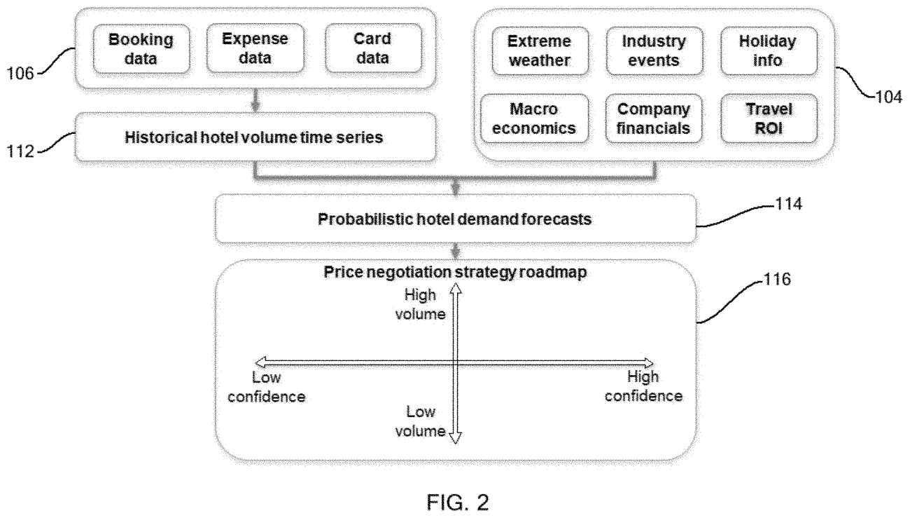

FIG. 2 illustrates a flow chart showing how the internal database 106 and the external databases 104 include certain data to determine a probabilistic hotel demand forecast 114, as discussed in greater detail below. The internal database 106, including booking data, expense data, card data, and the like, can be used to generate a historical hotel volume time series 112. This demand forecast 114 can then be used to provide the user with a price negotiation strategy roadmap 116. The roadmap 116 can provide a user with guidance for conducting a negotiation with the hotel. In some embodiments, the hotel user terminal device 110 (see FIG. 1) may electronically receive a request for pricing, such as a fixed price discount with a threshold number of stays within a predetermined period of time, or a discount pricing.

As shown in FIG. 2, the probabilistic hotel demand forecast 114 is determined for a given city or area and for a given time frame. Known statistical forecast models, such an autoregressive integrated moving average (ARIMA) model, a vector autoregression (VAR) model, curve-fitting exercises, prophet library, neural networks, long short term memory networks (LSTM), recurrent neural networks (RNN), or the like, may be used to output a probability distribution of hotel demands based on historical data for a hotel in a particular location. This probability distribution output may provide, for example, an expected hotel volume and a confidence level.

Methods according to embodiments of the present disclosure may also incorporate financial data into the expected hotel volume. This data may include, for a particular company utilizing the methods described herein, revenue and profit margin of last quarter, last year, and this quarter last year; quarter-to-quarter and year-to-year comparison of revenue; and profit margin, in the form of both actual ratio and flag indicator; revenue and profit margin decomposed by function lines; and the like.

The methods according to embodiments of the present disclosure can analyze the data from the internal and external databases, including the financial data, and compare this data to historic hotel demand to create the probabilistic hotel demand forecast. The methods may compare historic hotel demand over past weeks, months or even years to learn how various changes, such as financial changes, can affect hotel demand. The methods can continually update its forecast model through the use of real historic data in order to create the most accurate probabilistic hotel demand forecast model to provide an up-to-date probabilistic hotel demand forecast. This element of unsupervised continual machine learning may occur via a processor of the user terminal device 108 or may occur on the network 102, for example.

For example, if, based on historic data, hotel demand increases 10 percent when earnings per share beats expectations by 2 to 8 cents, this data can be used to help provide the probabilistic hotel demand forecast for a quarter following such a financial result. For example, if the company recently reported that their earnings per share beat expectations by 5 cents, the probabilistic hotel demand forecast model can adjust its forecast upward by 10 percent. If it is later shown that hotel demand actually increased 15 percent following the reported financial information, such historic data can be used to update the initial hotel demand increase of 10 percent.

As a further example of unsupervised machine learning methods that may be used in the probabilistic hotel demand forecast model, the model may weight data based on its age, if it is deemed necessary. For example, using the above example, if earnings per share beat expectations by 5 cents for each of eight quarters 4-5 years ago, and the probabilistic hotel demand forecast model predicted a 5 percent hotel demand increase, and the actual hotel demand increased 5 percent

With various financial data being reported at various intervals over the course of a year, the systems and methods of the present disclosure can continually monitor this public financial data and update the probabilistic hotel demand forecast accordingly.

A proof of concept study was conducted where a weekly forecast of hotel demands in NYC was determined with and without the financial component incorporated therein. The results of this study are shown in the table below:

| | With Financial | Without Financial |
|---|---|---|
| | Features | Features |
| MAE | 219.5 | 312.2 |
| Relative MAE | 11.1% | 16.7% |

As can be seen from the table, the mean actual error (MAE) is significantly decreased when the financial features are considered when determining the expected hotel volume. Accordingly, embodiments of the present disclosure utilize such financial data in order to ascertain a more accurate expected hotel volume. Such improved precision has the technical effect of conserving valuable network 102 and computational 108 resources by reducing the number of iterations and time to find agreement between the user terminal device 108 and a hotel user terminal device 110. By virtue of displaying one or more options on the hotel user terminal device 110 that are more effective, the efficiency of the user terminal device 108 is improved.

Once the demand forecast is determined, with its confidence level, this data may be used in a forecast model, where the user terminal 108 can determine whether the predicted volume is high or low. Within a given time period, for a given city and hotel (or hotel chain), according to past experience, threshold volume N* can be determined by the equation below:

N*=a %=N₀·b % (Eq. 1)

where

a % denotes a percentage of company hotel demands that are served by this hotel (or hotel chain);

N₀ denotes the allocation of this hotel (chain) for enterprise travel; and

b % denotes a percentage of the allocation that is taken by company employees, where

Thus, the resulting strategy, where N denotes the expected volume, would be as follows: (1) where N==N*, this indicates a high volume and a hybrid pricing scheme should be considered; and (2) where N<N*, this indicates a low volume and a fixed pricing scheme should be considered.

Once the expected volume is determined, then the confidence for this volume should be explored. In a low expected volume condition, the threshold confidence level P* can be determined by the following formula of equation 2. below:

N·p₁=P*·N·p₂+(1−P*)·(N·p₁+C) (Eq. 2)

where

N denotes the expected volume, as determined by the forecast model discussed above;

p₁ and d₁ denote the fixed rate and discount level for dynamic rate without volume commitment, respectively;

p₂ and d₂ denote the fixed rate and discount level for dynamic rate with volume commitment, respectively;

C denotes the penalty if the volume commitment is not reached;

P denotes the probability of meeting the commitment level, derived from the probabilistic demand forecasts, hence the confidence level; and

p denotes the market price,

In a high expected volume condition, the threshold level P* can be determined by the following formula of equation 3 below:

N₀·p₁+(N−N₀)·p·d₁=P*·[N₀·p₂+(N−N₀)·p·d₂]+(1−P*)·[N₀p₁+(N−N₀)·p·d₁+C] (Eq. 3)

where

N denotes the expected volume, as determined by the forecast model discussed above;

N₀ denotes the allocation of this hotel (chain) for enterprise travel;

p₁ and d₁ denote the fixed rate and discount level for dynamic rate without volume commitment, respectively;

p₂ and d₂ denote the fixed rate and discount level for dynamic rate with volume commitment, respectively;

C denotes the penalty if the volume commitment is not reached;

P denotes the probability of meeting the commitment level, derived from the probabilistic demand forecasts, hence the confidence level; and

p denotes the market price.

The overall strategy may be that, when P=>P*, this indicates high confidence and an aggressive negotiation should be pursued with committing certain volumes and being willing to take a penalty if not reached. When P<P*, this indicates low confidence and no volume commitment should be pursued.

The system can output to the user a roadmap 116 of FIG. 2 describing a plan for action in determining a pricing strategy. As discussed above, the roadmap 116 may be used to provide firm evidence to support a company's pricing strategy and such evidence may be electronically delivered from the network 102 to the hotel user terminal device 110, where the evidence supports the company's rationale for a desired pricing strategy. The system may be configured to provide an electronic communication between the user terminal device 108 and the hotel user terminal device 110. In some embodiments, the system can be configured to accept user input into the user terminal device 108 to permit a hotel pricing offer to the hotel user terminal device 110.

For example, in one embodiment, the roadmap 116 may be a two-by-two matrix of predicted volume versus confidence. When the predicted volume is high and the confidence is high, the roadmap 116 can indicate on a display of the user terminal 108 that a hybrid pricing strategy, using fixed and dynamic pricing, should be used with an aggressive negotiation, including volume commitments and penalties, where penalties refer to a penalty the company must pay if the company does not meet the volume commitment. As used herein, a high volume is where the predicted volume is greater that the volume threshold. Further, as used herein, a high confidence is where the probability of meeting a commitment level is greater than a threshold confidence level. In one embodiment, a data packet is sent from the user terminal 108 to the hotel user terminal 110 over the network 102 to provide the hybrid price strategy. More particularly, the data packet is configured to display on a display of the hotel user device 110 the fixed and dynamic pricing proposals, the volume of commitments, and penalties, as discussed above. When a selection is made at the hotel user terminal 110 (e.g., automatically or by an authorized administrator of the hotel computing device 110, the user terminal 108 can receive a response therefrom, indicating whether agreement has been reached between the user terminal device 108 and the hotel terminal device 110.

When the predicted volume is high and the confidence is low, the roadmap 116 can indicate to the user that a hybrid pricing strategy, using fixed and dynamic pricing, should be used with an emphasis on dynamic rates without any volume commitment or penalty. When the predicted volume is low and the confidence is high, the roadmap 116 can indicate on a user interface of the user device 108 that a fixed rate should be used with an aggressive negotiation, including volume commitments and penalties. In one embodiment, a data packet is sent to the hotel user terminal 110 to display the fixed pricing strategy, volume commitments and penalties.

Finally, when the predicted volume is low and the confidence is low, the roadmap 116 can indicate on a display of the user terminal 108 that a fixed rate should be used with no volume commitments or penalties. In one embodiment, a data packet is sent to the hotel user terminal 110 to display the fixed pricing strategy.

Referring now to FIG. 3, the system at the user terminal device 108 (see FIG. 1) may incorporate an iterative process 300 if the hotel rejects a pricing proposal. In step 302, the pricing proposal, provided by the user terminal device 108 based on the recommendation of the system, can be presented on a display of the hotel user terminal 110. At step 302, the user terminal device 108 may provide bottom line figures of the fixed rate p₀, the discount rate d₀, the volume commitment V and the penalty if the volume commitment is not met C. For example, if the predicted volume is low and the confidence is low, the roadmap 116 would display a recommendation of a fixed rate with no volume commitment or penalty. Accordingly, the system would need only to consider a bottom line for the fixed rate, or, in other words, a maximum fixed rate. In some embodiments, the bottom line figures may be provided by a user. In other embodiments, the bottom line figures may be generated by the system based on historical data for the particular hotel in a particular location.

If the proposal is accepted, in step 304, then a deal is reached in step 306 and the process ends. However, if the proposal is rejected (i.e., “No” at decision block 304), in step 308, the pricing proposal is updated by at the user terminal device 108. In some embodiments, the user may provide an updated pricing proposal based on the recommendation provided in the roadmap 116. In other embodiments, the system may automatically generate a revised pricing proposal by adjusting one or more of the figures of the proposal and sending the proposal back to the hotel user terminal device 110. The revised pricing proposal may, for example, adjust one or more elements of the pricing proposal by a predetermined percentage, of course, up to the bottom line value. In other embodiments, the revised pricing proposal may be based on analysis of historical data where the system may find which pricing components were previously accepted by the particular hotel and revise the pricing proposal accordingly. In some embodiments, the system may prompt a user, on the user terminal device 108, to authorize the automatically generated revised pricing proposal before delivering it to the hotel user terminal device 110.

Based on the determined pricing strategy, the user terminal device 108 can determine whether the pricing proposal has reached any of the relevant bottom lines (i.e., in step 310, the system checks to determine if the fixed rate bottom line, p₀, entered in step 302 described above has been reached). If the discount rate do is a relevant bottom line for the pricing strategy generated by the system, then the method would check, at step 312, if the bottom line is reached with respect to the discount rate d₀. Similarly, if the volume commitment V and the penalty if the volume commitment is not met C is a relevant bottom line for the pricing strategy generated by the system, then the method would check, at step 314, if the bottom line is reach with respect to the volume commitment V and the penalty if the volume commitment is not met C.

If all of the relevant bottom line elements (p₀, d₀, V and C) are at the bottom line, as determined at step 316, then the system recommends terminating negotiations with the hotel at step 318 and the user terminal device 108 would no longer send proposals to the hotel user terminal device 110. If all the relevant bottom line elements are not at the bottom line, as determined at step 316, then the price can be adjusted at step 320 and the process may resume at step 304.

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer implemented method, comprising:
receiving a first set of data comprising financial data of a company and at least one of holiday data, industrial event data, or weather data;
computing a probabilistic hotel demand forecast for a hotel in a location based on a statistical analysis of prior hotel stays at the hotel in the location with an adjustment based on at least the financial data of the first set of data, wherein the adjustment is computed by the computer based on a prior effect of at least the financial data on a number of prior hotel stays; and
displaying on a user terminal device, the probabilistic hotel demand forecast for the hotel in the location.

2. The method according to claim 1, further comprising updating the adjustment as additional financial data of the company is released.

3. The method according to claim 1, further comprising calculating, on the user terminal device, a threshold volume for the hotel in the location.

4. The method according to claim 3, further comprising:
comparing the threshold volume to a forecasted volume generated by the probabilistic hotel demand forecast;
indicating a high volume condition on a display of the user terminal device when the forecasted volume is greater than or equal to the threshold volume; and
indicating a low volume condition on the display of the user terminal device when the forecasted volume is less than the threshold volume.

5. The method according to claim 4, wherein a hybrid pricing strategy is displayed on the user terminal device when the high volume condition is indicated.

6. The method according to claim 4, wherein a fixed pricing strategy is displayed on the user terminal device when the low volume condition is indicated.

7. The method according to claim 1, further comprising calculating, on the user terminal device, a threshold confidence level for the hotel in the location.

8. The method according to claim 7, further comprising:
comparing the threshold confidence level to a forecasted confidence level generated by the probabilistic hotel demand forecast;
upon determining that the forecasted confidence level is greater than or equal to the threshold confidence level, indicating a high confidence condition; and
upon determining that the forecasted confidence level is less than the threshold confidence level, indicating a low confidence condition.

9. The method according to claim 8, further comprising, upon determining the high confidence condition, displaying, on the user terminal device, a pricing strategy comprising committing to certain volumes and being willing to take a penalty if the certain volumes are not reached.

10. The method according to claim 8, further comprising, upon determining the low confidence condition, displaying, on the user terminal device, a pricing strategy comprising a no volume commitment.

11. The method according to claim 1, further comprising:
sending the pricing strategy from the user terminal device to hotel user terminal device for approval;
receiving a response to the pricing strategy from the hotel user terminal device;
upon determining from the received response that the pricing strategy is accepted, accepting the pricing strategy for the hotel; and
upon determining from the received response that the pricing strategy is not accepted, modifying the pricing strategy based on historical pricing strategy data of the hotel and sending the modified pricing strategy from the user terminal device to the hotel user terminal device.

12. A computer program product for forecasting a hotel demand, the computer program product comprising a computer readable storage medium having program instructions embodied therewith, the program instructions executable by a user terminal device to cause the user terminal device to:
receive a first set of data comprising financial data of a company and at least one of holiday data, industrial event data, or weather data;
compute a probabilistic hotel demand forecast for a hotel in a location based on a statistical analysis of prior hotel stays at the hotel in the location with an adjustment based on at least the financial data of the first set of data, wherein the adjustment s computed by the user terminal device based on a prior effect of at least the financial data on a number of prior hotel stays; and
displaying on the user terminal device, the probabilistic hotel demand forecast for the hotel in the location.

13. The computer program product of claim 12, wherein the program instructions cause the user terminal device to:
calculate a threshold volume for the hotel in the location;
compare the threshold volume to a forecasted volume generated by the probabilistic hotel demand forecast;
indicate a high volume condition when the forecasted volume is greater than or equal to the threshold volume; and
indicate a low volume condition when the forecasted volume is less than the threshold volume.

14. The computer program product of claim 13, wherein the program instructions cause the user terminal device to:
display, on the user terminal device, a hybrid pricing strategy when the high volume condition is indicated; and
display, on the user terminal device, a fixed pricing strategy when the low volume condition is indicated.

15. The computer program product of claim 12, wherein the program instructions cause the user terminal device to:
calculate a threshold confidence level for the hotel in the location;
compare the threshold confidence level to a forecasted confidence level generated by the probabilistic hotel demand forecast;
indicate a high confidence condition when the forecasted confidence level is greater than or equal to the threshold confidence level; and
indicate a low confidence condition when the forecasted confidence level is less than the threshold confidence level.

16. The computer program product of claim 15, wherein the program instructions cause the user terminal device to:
upon determining the high confidence condition, display, on the user terminal device, a pricing strategy comprising committing to certain volumes and being willing to take a penalty if the certain volumes are not reached; and
upon determining the low confidence condition, display, on the user terminal device, a pricing strategy comprising no volume commitment.

17. The computer program product of claim 15, wherein the program instructions cause the user terminal device to:
send the pricing strategy from the user terminal device to hotel user terminal device for approval;
receive a response to the pricing strategy from the hotel user terminal device;
upon determining from the received response that the pricing strategy is accepted, accept the pricing strategy for the hotel; and
upon determining from the received response that the pricing strategy is not accepted, modify the pricing strategy based on historical pricing strategy data and send the modified pricing strategy from the user terminal device to the hotel user terminal device for approval.

18. A computing device comprising:
a processor;
a network interface coupled to the processor to enable communication over a network;
a user interface coupled to the processor;
a storage device coupled to the processor;
a code stored in the storage device, wherein an execution of the code by the processor configures the computing device to perform acts comprising:
receiving data comprising financial data of a company and at least one of holiday data, industrial event data, or weather data; and
computing a probabilistic hotel demand forecast for a hotel in a location based on a statistical analysis of prior hotel stays at the hotel in the location with an adjustment based on at least the financial data, wherein the adjustment is computed based on a prior effect of at least the financial data on a. number of prior hotel stays;
displaying, on the user interface, the probabilistic hotel demand forecast for the hotel in the location.

19. The computing device of claim 18, wherein an execution of the code by the processor further configures the computing device to perform an act comprising calculating a threshold volume for the hotel in the location.

20. The system of claim 18, wherein an execution of the code by the processor further configures the computing device to perform an act comprising calculating a threshold confidence level for the hotel in the location.
